(19) United States
(12) Patent Application Publication
(10) Pub. No.: US 2009/0109506 A1
(43) Pub. Date: Apr. 30, 2009

(54) DOUBLE-SIDE SCANNING DEVICE

(76) Inventor: Hsueh-Jung LU, Hsinchu (TW)

Correspondence Address: BIRCH STEWART KOLASCH & BIRCH, PO BOX 747, FALLS CHURCH, VA, 22040-0747, US

(21) Appl. No.: 11/924,442

(22) Filed: Oct. 25, 2007

(51) Int. Cl. H04N 1/46

(52) U.S. Cl. 358/511

(57) ABSTRACT

A double-side scanning device includes glass platforms having an upper glass platform and a lower glass platform separated apart form each other to define a sheet-passage. Each of the glass platforms is divided into a scanning area and a light penetrating area. Light sources include a first light source disposed beneath the scanning area of the lower glass platform and a second light source disposed above the scanning area of the upper glass platform. Reflectors include first reflectors arranged beneath the lower glass platform and second reflectors arranged above the upper glass platform. A prism mounted at a side of the light penetrating areas of the glass platforms has at least two reflex surfaces for respectively receiving the image incident light from the first reflectors and the second reflectors. A lens is mounted at back of the prism. And an image-gathering device is disposed at back of the lens.

### BACKGROUND OF THE INVENTION

1. Field of the Invention

The present invention relates to a scanning device, and more particularly to a double-side scanning device which is used in a scanner, an electrograph or the like for scanning images formed on both sides of a sheet at the same time. 2. The Related Art

Nowadays, a scanner is an important peripheral of a computer. Sheets or pictures are fed in the scanner for being scanned and then read into the computer. As well known that many conventional scanners are capable of single-side image scanning. But as the rapid development of modern electronic industry, a double-side scanning device capable of simultaneously scanning images formed on both sides of a sheet is provided on the market.

FIG. 2 shows an exemplary double-side scanning device 200. The double-side scanning device 200 includes a first scanning device 210, a second scanning device 220 disposed beneath the first scanning device 210 and two glass windows 240 that are pervious to light and disposed between the first scanning device 210 and the second scanning device 220. The two glass windows 240 are separated apart from each other to define a scanning passage therebetween. The first scanning device 210 includes a first image-gathering device 211, a first lens 212, first mirrors 213 and two first light sources 214. The first scanning device 210 defines a first light-receiving hole 215 between the first light sources 214. The second scanning device 220 has the same constitution as the first scanning device 210, which includes a second image-gathering device 221, a second lens 222, second mirrors 223, two second light sources 224 and a second light-receiving hole 225.

In operation, a sheet 230 enters the scanning passage defined between the two glass windows 240. The first light sources 214 and the second light sources 224 emit light onto the two glass windows 240 to illuminate a right surface and a reverse surface of the sheet 230 respectively. When the sheet 230 arrives below the first light-receiving hole 215 or above the second light-receiving hole 225, one of the first mirrors 213 faces the right surface of the sheet 230 and attains image incident light of the right surface of the sheet 230. The image incident light is reflected to the first lens 212 by the other first mirrors 213 and then is gathered by the first image-gathering device 211. At the same time, one of the second mirrors 223 faces the reverse surface of the sheet 230 and attains image incident light of the reverse surface of the sheet 230. The image incident light of the reverse surface of the sheet 230 is reflected to the second lens 222 by the other second mirrors 223 and then is gathered by the second image-gathering device 221. The first image-gathering device 211 and the second image-gathering device 221 handle light signals that are received from the first lens 212 and the second lens 222 respectively. Then, the double-side scanning device 200 finishes scanning images formed on both sides of the sheet 230.

However, the double-side scanning device 200 includes a first scanning device 210 and a second scanning device 220, and the first scanning device 210 and the second scanning device 220 have the same constitution. Thereby, the double-side scanning device 200 needs two lenses 212, 222 and two image-gathering devices 211, 221, increasing the manufacture cost of the double-side scanning device 200.

### SUMMARY OF THE INVENTION

Accordingly, an object of the present invention is to provide a double-side scanning device for scanning images formed on both sides of a sheet at the same time.

To achieve the object, the double-side scanning device includes glass platforms. The glass platforms include an upper glass platform and a lower glass platform separated apart form each other to define a sheet-passage therebetween. Each of the glass platforms is divided into a scanning area and a light penetrating area along the scanning direction. Light sources include a first light source disposed beneath the scanning area of the lower glass platform and a second light source disposed above the scanning area of the upper glass platform for emitting light onto the glass platforms to illuminate a reverse side and a right side of the sheet placed in the sheet-passage respectively. Reflectors include first reflectors arranged beneath the lower glass platform and second reflectors arranged above the upper glass platform for attaining image incident light of the reverse side and the right side of the sheet respectively. A prism mounted at a side of the light penetrating areas of the glass platforms has at least two reflex surfaces for respectively receiving the image incident light from the first reflectors and the second reflectors. A lens is mounted at back of the prism for receiving the image incident light from the prism. And an image-gathering device is disposed at back of the lens for receiving the image incident light from the lens.

As described above, the double-side scanning device uses one lens and one image-gathering device to realize double-side scanning function, which is simplified comparatively to a conventional double-side scanning device, reducing the manufacture cost thereof.

### BRIEF DESCRIPTION OF THE DRAWINGS

The present invention will be apparent to those skilled in the art by reading the following description of a preferred embodiment thereof, with reference to the attached drawings, in which:

FIG. 1 is a schematic view of a double-side scanning device in accordance with the present invention; and

FIG. 2 is a schematic view of a prior double-side scanning device.

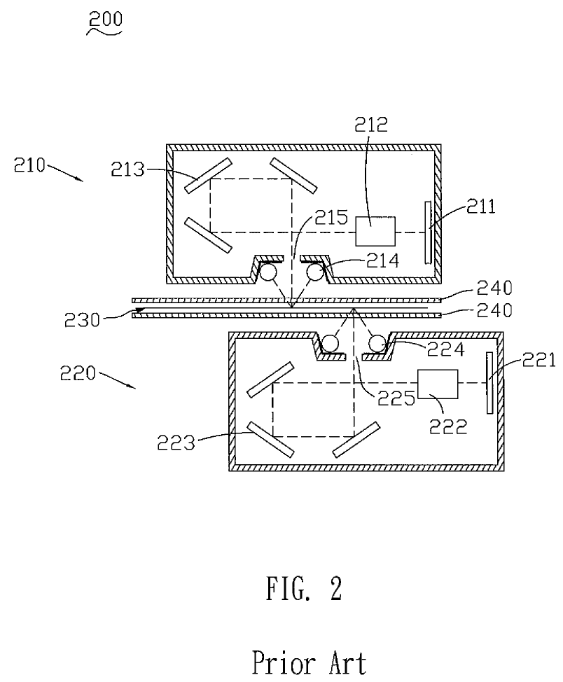

### DETAILED DESCRIPTION OF THE PREFERRED EMBODIMENT

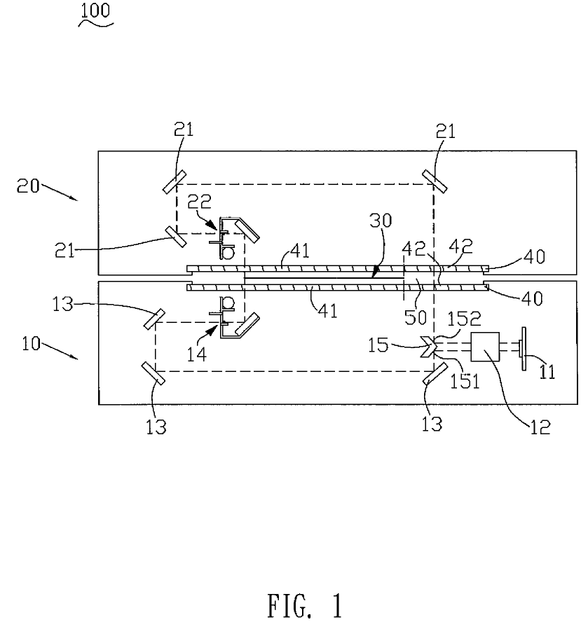

Referring to FIG. 1, a double-side scanning device 100 of the present invention includes a first scanning device 10, a second scanning device 20 seated above the first scanning device 10 and a pair of glass platforms 40 disposed between the first scanning device 10 and the second scanning device 20. The two glass platforms 40 are separated apart from each other to form a sheet-passage 50 therebetween for loading a sheet 30 that needs to be scanned. The glass platforms 40 are pervious to light.

Please continually refer to FIG. 1. The first scanning device 10 includes an image-gathering device 11, a lens 12 disposed at front of the image-gathering device 11, four first reflectors 13, a first light source 14 and a prism 15 having at least two reflex surfaces 151, 152 perpendicular with each other and arranged at front of the lens 12. In a preferred embodiment, the image-gathering device 11 is a CCD (charge coupled device) or the like, which is capable of transforming a light signal into an electric signal. The first light source 14 is disposed beneath the glass platform 40 that abuts against the top of the first scanning device 10. One of the first reflectors 13 faces the first light source 14 for attaining image incident light of a reverse side of the sheet 30 and mirroring the image incident light to the other three first reflectors 13. The image-gathering device 11, the lens 12 and the prism 15 are on substantially the same line and disposed in the scanning direction.

The second scanning device 20 includes four second reflectors 21 and a second light source 22. The second light source 22 is disposed above the glass platform 40 that abuts against the bottom of the second scanning device 20. The second reflectors 21 are arranged as the same as the first reflectors 13 and substantially symmetrical to the first reflectors 13.

Each of the glass platforms 40 is divided into a scanning area 41 and a light penetrating area 42 along the scanning direction. The scanning areas 41 disposed between the first light source 14 and the second light source 22 are used to carry the sheet 30. The light penetrating areas 42 above the prism 15 allow the image incident light from the second reflectors 21 of the second scanning device 20 to pass through and arrive at the reflex surface 152 of the prism 15.

In operation, the sheet 30 enters the sheet-passage 50 defined between the two glass platforms 40. The first light source 14 and the second light source 22 move along the scanning areas 41 of the glass platforms 40 at the same time, or the sheet 30 moves along the scanning areas 41 in condition that the first light source 14 and the second light source 22 are fixed to be immovable below and above the scanning areas 41 respectively. The first light source 14 emits light onto the glass platform 40 that abuts against the top of the first scanning device 10 and illuminates the reverse side of the sheet 30. The first reflector 13 facing the first light source 14 attains image incident light of the reverse side of the sheet 30 and then mirrors the image incident light to the reflex surface 151 of the prism 15 by the other three first reflectors 13. At the same time, the second light source 22 emits light onto the glass platform 40 that abuts against the bottom of the second scanning device 20 and illuminates a right side of the sheet 30. The second reflector 21 facing the second light source 22 attains image incident light of the right side of the sheet 30 and then mirrors the image incident light to the other three second reflectors 21. The image incident light from the second reflectors 21 vertically penetrates the light penetrating areas 42 of the glass platforms 40 to the reflex surface 152 of the prism 15. The image incident light that the prism 15 receives from the first reflectors 13 and the second reflectors 21 is parallel reflected to the lens 12. The lens 12 receives the image incident light and transmits the image incident light to the image-gathering device 1. Then, the image-gathering device 11 converts light signals into electric signals to be handled.

As described above, the double-side scanning device 100 includes one lens and one image-gathering device, which is simplified comparatively to a conventional double-side scanning device which includes two prisms, two lenses and two image-gathering devices. It can be seen that the present invention leaves out one lens and one image-gathering device, reducing the manufacture cost of the double-side scanning device 100.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A double-side scanning device, comprising:
glass platforms, including an upper glass platform and a lower glass platform separated apart form each other to define a sheet-passage therebetween, each of the glass platforms divided into a scanning area and a light penetrating area along the scanning direction;
light sources, including a first light source disposed beneath the scanning area of the lower glass platform and a second light source disposed onto the glass platforms to illuminate a reverse side and a right side of a sheet placed in the sheet-passage respectively;
reflectors, including first reflectors arranged beneath the lower glass platform and second reflectors arranged above the upper glass platform for attaining image incident light of the reverse side and the right side of the sheet respectively;
a prism, mounted at a side of the light penetrating areas of the glass platforms, having at least two reflex surfaces for respectively receiving the image incident light from the first reflectors and the second reflectors;
a lens, mounted at back of the prism for receiving the image incident light from the prism; and
an image-gathering device, disposed at back of the lens for receiving the image incident light from the lens.

2. The double-side scanning device as claimed in claim 1, wherein the two reflex surfaces of the prism are perpendicular with each other and parallel mirror the image incident light to the lens.
